(19) United States
(12) Patent Application Publication
(10) Pub. No.: US 2026/0230155 A1
(43) Pub. Date: Aug. 6, 2026

(54) BEAM CORRESPONDENCE CONDITIONS WITH JOINT BEAM PAIR PREDICTION

(71) Applicant: QUALCOMM Incorporated, San Diego, CA (US)

(72) Inventors: Qiaoyu LI, Beijing (CN); Sumant Jayaraman IYER, San Diego, CA (US); Mahmoud TAHERZADEH BOROUJENI, San Diego, CA (US); Tao LUO, San Diego, CA (US)

(21) Appl. No.: 19/151,938

(22) PCT Filed: Mar. 20, 2023
(86) PCT No.: PCT/CN2023/082431

§ 371 Date: Jul. 29, 2025

(51) Int. Cl. H04B 7/06; H04W 24/08

(52) U.S. Cl. CPC H04B 7/0696; H04W 24/08

(57) ABSTRACT

Methods, systems, and devices for wireless communications are described. A user equipment (UE) may transmit a control message indicating a capability of the UE to support beam correspondence between a downlink receive beam and an uplink transmit beam using beam prediction. The UE may measure one or more signals using one or more downlink receive beams of the UE. The UE may perform a prediction procedure for a predicted downlink receive beam of the UE and a predicted downlink transmit beam of a network entity. The predicted downlink receive beam may correspond to a predicted up-Capability link transmit beam based on one or more measurement predictions satisfying a threshold.

### CROSS REFERENCE

The present Application is a 371 national phase filing of International PCT Application No. PCT/CN2023/082431 by LI et al., entitled “BEAM CORRESPONDENCE CONDITIONS WITH JOINT BEAM PAIR PREDICTION,” filed Mar. 20, 2023, which is assigned to the assignee hereof, and which is expressly incorporated by reference in its entirety herein.

### FIELD OF TECHNOLOGY

The following relates to wireless communications, including beam correspondence conditions with joint beam pair prediction.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support beam correspondence conditions with joint beam pair prediction. For example, the described techniques provide for a user equipment (UE) to predict measurements for one or more predicted downlink transmit beams or virtual resources of a network entity. The UE may predict a corresponding downlink receive beam based on the predicted downlink transmit beams. The UE may compare the predicted measurements to one or more thresholds associated with beam correspondence using predictions. If the predicted measurements satisfy the one or more thresholds, the UE may perform beam correspondence based on the predictions. For example, the UE may select or identify an uplink transmit beam that corresponds to the predicted downlink receive beam.

A method for wireless communications at a user equipment (UE) is described. The method may include transmitting a control message indicating a capability of the UE to support beam correspondence between a downlink receive beam and an uplink transmit beam using beam prediction, measuring one or more signals using one or more downlink receive beams of the UE, and performing a prediction procedure for a predicted downlink receive beam of the UE and a predicted downlink transmit beam of a network entity, where the predicted downlink receive beam corresponds to a predicted uplink transmit beam based on one or more measurement predictions satisfying a threshold.

An apparatus for wireless communications at a UE is described. The apparatus may include a processor, memory coupled with the processor, and instructions stored in the memory. The instructions may be executable by the processor to cause the apparatus to transmit a control message indicating a capability of the UE to support beam correspondence between a downlink receive beam and an uplink transmit beam using beam prediction, measure one or more signals using one or more downlink receive beams of the UE, and perform a prediction procedure for a predicted downlink receive beam of the UE and a predicted downlink transmit beam of a network entity, where the predicted downlink receive beam corresponds to a predicted uplink transmit beam based on one or more measurement predictions satisfying a threshold.

Another apparatus for wireless communications at a UE is described. The apparatus may include means for transmitting a control message indicating a capability of the UE to support beam correspondence between a downlink receive beam and an uplink transmit beam using beam prediction, means for measuring one or more signals using one or more downlink receive beams of the UE, and means for performing a prediction procedure for a predicted downlink receive beam of the UE and a predicted downlink transmit beam of a network entity, where the predicted downlink receive beam corresponds to a predicted uplink transmit beam based on one or more measurement predictions satisfying a threshold.

A non-transitory computer-readable medium storing code for wireless communications at a UE is described. The code may include instructions executable by a processor to transmit a control message indicating a capability of the UE to support beam correspondence between a downlink receive beam and an uplink transmit beam using beam prediction, measure one or more signals using one or more downlink receive beams of the UE, and perform a prediction procedure for a predicted downlink receive beam of the UE and a predicted downlink transmit beam of a network entity, where the predicted downlink receive beam corresponds to a predicted uplink transmit beam based on one or more measurement predictions satisfying a threshold.

In some examples of the method, apparatuses, and non-transitory computer-readable medium described herein, performing the prediction procedure may include operations, features, means, or instructions for performing the prediction procedure to obtain a predicted reference signal measurement for the predicted downlink receive beam, where the predicted downlink receive beam corresponds to the predicted uplink transmit beam based on the predicted reference signal measurement satisfying a predicted reference signal measurement threshold.

In some examples of the method, apparatuses, and non-transitory computer-readable medium described herein, the predicted reference signal measurement may be based on a mean of a set of multiple predicted reference signal measurements for the predicted downlink receive beam.

In some examples of the method, apparatuses, and non-transitory computer-readable medium described herein, performing the prediction procedure may include operations, features, means, or instructions for performing the prediction procedure to obtain a set of multiple predicted reference signal measurements for the predicted downlink receive beam, where the predicted downlink receive beam corresponds to the predicted uplink transmit beam based on at least one predicted reference signal measurement of the set of multiple predicted reference signal measurements satisfying a predicted reference signal measurement threshold.

In some examples of the method, apparatuses, and non-transitory computer-readable medium described herein, performing the prediction procedure may include operations, features, means, or instructions for performing the prediction procedure to obtain a confidence metric associated with the one or more measurement predictions, where the predicted downlink receive beam corresponds to the predicted uplink transmit beam based on the confidence metric satisfying a confidence metric threshold.

In some examples of the method, apparatuses, and non-transitory computer-readable medium described herein, the confidence metric may be associated with a standard deviation of a mean for the one or more measurement predictions.

In some examples of the method, apparatuses, and non-transitory computer-readable medium described herein, performing the prediction procedure may include operations, features, means, or instructions for performing the prediction procedure to obtain the one or more measurement predictions associated with a radio frequency spectrum band, where the threshold may be associated with the radio frequency spectrum band.

In some examples of the method, apparatuses, and non-transitory computer-readable medium described herein, performing the prediction procedure may include operations, features, means, or instructions for performing the prediction procedure to obtain the one or more measurement predictions associated with a beam direction from the network entity, where the threshold may be associated with the beam direction from the network entity.

In some examples of the method, apparatuses, and non-transitory computer-readable medium described herein, performing the prediction procedure may include operations, features, means, or instructions for performing the prediction procedure to obtain a predicted measurement for a spatial resource associated with the predicted downlink transmit beam and the predicted downlink receive beam, where the predicted downlink receive beam corresponds to the predicted uplink transmit beam based on the predicted measurement for the spatial resource satisfying the threshold.

In some examples of the method, apparatuses, and non-transitory computer-readable medium described herein, the predicted measurement for the spatial resource may be based on a mean of a set of multiple predicted measurements for the spatial resource.

In some examples of the method, apparatuses, and non-transitory computer-readable medium described herein, the spatial resource may be a virtual resource of the network entity.

In some examples of the method, apparatuses, and non-transitory computer-readable medium described herein, the spatial resource may be associated with an angle of arrival at the network entity or an angle of departure from the network entity, or both.

In some examples of the method, apparatuses, and non-transitory computer-readable medium described herein, performing the prediction procedure may include operations, features, means, or instructions for performing the prediction procedure to obtain a set of multiple predicted measurements for a spatial resource associated with the predicted downlink transmit beam and the predicted downlink receive beam, where the predicted downlink receive beam corresponds to the predicted uplink transmit beam based on at least one predicted measurement for the spatial resource of the set of multiple predicted measurements for the spatial resource satisfying the threshold.

Some examples of the method, apparatuses, and non-transitory computer-readable medium described herein may further include operations, features, means, or instructions for receiving control signaling indicating a set of multiple virtual resources of the network entity, where at least the predicted downlink transmit beam may be associated with a virtual resource of the set of multiple virtual resources.

In some examples of the method, apparatuses, and non-transitory computer-readable medium described herein, the control signaling identifies a beam shape or beam pointing direction associated with each virtual resource of the set of multiple virtual resources.

In some examples of the method, apparatuses, and non-transitory computer-readable medium described herein, measuring the one or more signals may include operations, features, means, or instructions for measuring a channel state information (CSI) reference signal (CSI-RS) or a synchronization signal block (SSB), or both, where the one or more measurement predictions may be associated with measuring the CSI-RS or measuring the SSB, or both.

In some examples of the method, apparatuses, and non-transitory computer-readable medium described herein, transmitting the control message may include operations, features, means, or instructions for transmitting the control message indicating the capability of the UE to support the beam correspondence between the downlink receive beam and the uplink transmit beam using a CSI-RS or using an SSB, or both.

In some examples of the method, apparatuses, and non-transitory computer-readable medium described herein, transmitting the control message may include operations, features, means, or instructions for transmitting the control message indicating the capability of the UE to support the beam correspondence between the downlink receive beam and the uplink transmit beam based on a virtual resource of the network entity, an angle of arrival, an angle of departure of the network entity, or any combination thereof.

A method for wireless communications at a network entity is described. The method may include receiving a control message indicating a capability of a UE to support beam correspondence between a downlink receive beam and an uplink transmit beam using beam prediction and transmitting one or more signals using one or more downlink transmit beams of the network entity based on the capability of the UE to support beam correspondence between the downlink receive beam and the uplink transmit beam using beam prediction.

An apparatus for wireless communications at a network entity is described. The apparatus may include a processor, memory coupled with the processor, and instructions stored in the memory. The instructions may be executable by the processor to cause the apparatus to receive a control message indicating a capability of a UE to support beam correspondence between a downlink receive beam and an uplink transmit beam using beam prediction and transmit one or more signals using one or more downlink transmit beams of the network entity based on the capability of the UE to support beam correspondence between the downlink receive beam and the uplink transmit beam using beam prediction.

Another apparatus for wireless communications at a network entity is described. The apparatus may include means for receiving a control message indicating a capability of a UE to support beam correspondence between a downlink receive beam and an uplink transmit beam using beam prediction and means for transmitting one or more signals using one or more downlink transmit beams of the network entity based on the capability of the UE to support beam correspondence between the downlink receive beam and the uplink transmit beam using beam prediction.

A non-transitory computer-readable medium storing code for wireless communications at a network entity is described. The code may include instructions executable by a processor to receive a control message indicating a capability of a UE to support beam correspondence between a downlink receive beam and an uplink transmit beam using beam prediction and transmit one or more signals using one or more downlink transmit beams of the network entity based on the capability of the UE to support beam correspondence between the downlink receive beam and the uplink transmit beam using beam prediction.

In some examples of the method, apparatuses, and non-transitory computer-readable medium described herein, receiving the control message may include operations, features, means, or instructions for receiving the control message indicating the capability of the UE to support the beam correspondence between the downlink receive beam and the uplink transmit beam using a CSI-RS or using an SSB, or both.

In some examples of the method, apparatuses, and non-transitory computer-readable medium described herein, receiving the control message may include operations, features, means, or instructions for receiving the control message indicating the capability of the UE to support the beam correspondence between the downlink receive beam and the uplink transmit beam based on a virtual resource of the network entity, an angle of arrival, an angle of departure of the network entity, or any combination thereof.

### BRIEF DESCRIPTION OF THE DRAWINGS

FIG. 1 shows an example of a wireless communications system that supports beam correspondence conditions with joint beam pair prediction in accordance with one or more aspects of the present disclosure.

FIG. 2 shows an example of a wireless communications system that supports beam correspondence conditions with joint beam pair prediction in accordance with one or more aspects of the present disclosure.

FIG. 3 shows an example of signal characteristic predictions that supports beam correspondence conditions with joint beam pair prediction in accordance with one or more aspects of the present disclosure.

FIG. 4 shows an example of a process flow that supports beam correspondence conditions with joint beam pair prediction in accordance with one or more aspects of the present disclosure.

FIGS. 5 and 6 show block diagrams of devices that support beam correspondence conditions with joint beam pair prediction in accordance with one or more aspects of the present disclosure.

FIG. 7 shows a block diagram of a communications manager that supports beam correspondence conditions with joint beam pair prediction in accordance with one or more aspects of the present disclosure.

FIG. 8 shows a diagram of a system including a device that supports beam correspondence conditions with joint beam pair prediction in accordance with one or more aspects of the present disclosure.

FIGS. 9 and 10 show block diagrams of devices that support beam correspondence conditions with joint beam pair prediction in accordance with one or more aspects of the present disclosure.

FIG. 11 shows a block diagram of a communications manager that supports beam correspondence conditions with joint beam pair prediction in accordance with one or more aspects of the present disclosure.

FIG. 12 shows a diagram of a system including a device that supports beam correspondence conditions with joint beam pair prediction in accordance with one or more aspects of the present disclosure.

FIGS. 13 and 14 show flowcharts illustrating methods that support beam correspondence conditions with joint beam pair prediction in accordance with one or more aspects of the present disclosure.

### DETAILED DESCRIPTION

In some wireless communications systems, a user equipment (UE) may support beam correspondence for selecting an uplink transmit beam. For example, the uplink transmit beam may be based on a downlink receive beam, such as by pointing in an opposite direction of the downlink receive beam. Beam correspondence may reduce overhead and processing power for selecting the uplink transmit beam. In some cases, the UE may be configured with conditions or requirements to use beam correspondence when selecting an uplink transmit beam. For example, a signal measurement (e.g., a reference signal measurement) made using the downlink receive beam may need to satisfy a threshold in order for the UE to use beam correspondence and select an uplink transmit beam based on the downlink receive beam. Some systems may support beam prediction, such as using artificial intelligence or a machine learning model to predict a downlink transmit beam (e.g., of a network entity) or an uplink receive beam (e.g., of a UE), or both. A UE may be able to predict a direction or receive beam configuration for a predicted downlink beam. However, in some systems, beam correspondence only has thresholds and conditions based on actual measurements. Therefore, the conditions to perform beam correspondence of these systems do not support beam correspondence using beam prediction.

The present disclosure provides techniques to implement beam correspondence using beam prediction. A UE may be configured with conditions for performing beam correspondence using beam prediction. For example, the UE may perform a beam pair prediction to obtain predicted measurements for one or more predicted receive beams. If the measurements satisfy a threshold, the UE may use beam correspondence to identify a predicted uplink transmit beam that corresponds to the predicted downlink receive beam. In some examples, the conditions may be based on signal or channel characteristics of the predicted downlink receive beams. For example, the prediction-based conditions may be based on a predicted reference signal received power (RSRP) of the predicted receive beam or a standard deviation of the predicted RSRP, or both. In some examples, the UE may obtain the predicted measurements based on actual measurements of a channel state information (CSI) reference signal or a synchronization signal block (SSB), or both.

In some examples, the UE may predict measurements for a virtual resource of a network entity, such as a beam direction or beam shape which is not actually transmitted by the network entity, but is indicated by the network entity as a beam prediction target. The virtual resources may be based on an angle of arrival or an angle of departure from the network entity. To perform beam correspondence using beam predictions, the UE may report a capability to support beam correspondence using beam predictions. The UE may indicate a capability to perform beam correspondence based on predicted CSI measurements or predicted SSB measurements, or both, for actual predicted transmit beams or virtual resources, or both.

Aspects of the disclosure are initially described in the context of wireless communications systems. Aspects of the disclosure are further illustrated by and described with reference to apparatus diagrams, system diagrams, and flowcharts that relate to beam correspondence conditions with joint beam pair prediction.

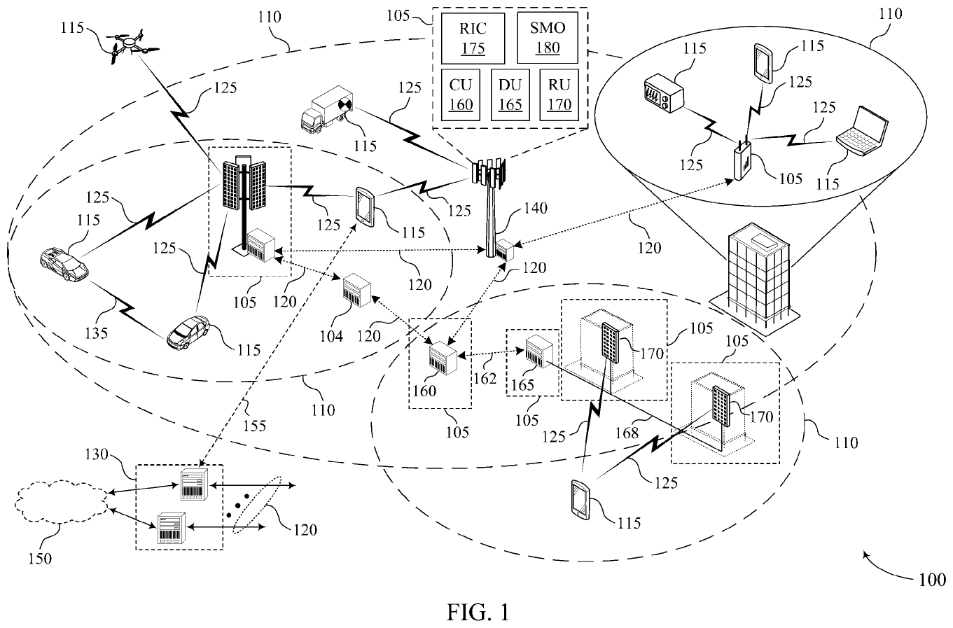

FIG. 1 shows an example of a wireless communications system 100 that supports beam correspondence conditions with joint beam pair prediction in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUS 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN.

Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support beam correspondence conditions with joint beam pair prediction as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Af) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHZ.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas.

Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, the wireless communications system 100 may support virtual resources. A virtual resource may correspond a spatial resource which may not correspond to an actual spatial resource of a network entity 105 or a UE 115. For example, a network entity 105 may configure one or more virtual resources, which may correspond to beam prediction targets or a spatial direction from the network entity 105 which may or may not have a corresponding physical beam direction. In some examples, the wireless communications system 100 may additionally, or alternatively, support an angle-of-arrival or angle-of-departure designation for spatial directions from a wireless device such as a UE 115 or a network entity 105. An angle-of-arrival may correspond to an angle of signal received at the wireless node, and an angle-of-departure may correspond to an angle of signal transmitted from the wireless device. In some examples, an angle-of-arrival or an angle-of-departure may or may not correspond to physical beam directions of the wireless device. Virtual resources, angle-of-arrival, and angle-of-departure may be examples of directions from the wireless node, and may be communicated to or from the wireless node to facilitate directional beamforming or ideal directional beamforming.

Some wireless communications systems, such as the wireless communications system 100, may support beam correspondence for a UE 115 to select an uplink transmit beam. For example, the uplink transmit beam may be based on a downlink receive beam, such as by pointing in an opposite direction of the downlink receive beam. Beam correspondence may reduce overhead and processing power for selecting the uplink transmit beam. In some cases, the UE may be configured with conditions or requirements to use beam correspondence when selecting an uplink transmit beam. For example, a signal measurement (e.g., a reference signal measurement) made using the downlink receive beam may need to satisfy a threshold in order for the UE to use beam correspondence and select an uplink transmit beam based on the downlink receive beam.

A beam correspondence requirement or beam correspondence condition for a UE 115 may be based on a UE minimum peak effective isotropic radiated power (EIRP), a UE spherical coverage, and a beam correspondence tolerance. The beam correspondence requirement may be fulfilled if the UE 115 satisfies the conditions and based on the capability of the UE 115.

For example, if the UE 115 supports beam correspondence without uplink beam sweeping, the UE 115 may need to meet the minimum peak EIRP requirement and spherical coverage requirement with autonomously chosen uplink beams and without uplink beam sweeping. If the UE 115 meets those requirements or conditions, the UE 115 meets the beam correspondence tolerance requirement.

In some examples, such as if the UE 115 supports SSB-based beam correspondence or CSI-RS-based beam correspondence, the UE 115 may need to satisfy side conditions in order to satisfy the beam correspondence criteria. The side conditions may include that the downlink reference signals (e.g., CSI-RS and SSB) are provided, and a Type-D quasi co-location is maintained between the SSBs and CSI-RS. In some examples, the side conditions may include that the reference measurement channel for beam correspondence are fulfilled according to a CSI-RS configuration. In some examples, for beam correspondence, conditions for RSRP measurements (e.g., Layer 1 RSRP measurements) of the downlink receive beams may need to satisfy one or more thresholds. The thresholds may be configured at the UE 115 and may be based on a radio frequency spectrum band or operating band of the downlink receive beam. For example, a reference signal measurement on band n257 may need to have a minimum RSRP of −96.2 dB to satisfy a measurement threshold.

In some examples, the UE 115 may need to meet additional requirements, or side requirements, to apply beam correspondence. For example, if the UE 115 If the UE 115 supports beam correspondence without uplink beam sweeping and supports SSB-based beam correspondence, the UE 115 may need to meet the minimum peak EIRP requirement and spherical coverage requirement using one or more side conditions for SSB-based enhanced beam correspondence requirements. These side conditions Some systems may support beam prediction, such as using artificial intelligence or a machine learning model to predict a downlink transmit beam (e.g., of a network entity) or an uplink receive beam (e.g., of a UE 115), or both. In some examples, the UE 115 may perform codebook-based spatial domain prediction, or beam prediction. Codebook-based beam predictions may use fewer beam measurements, which may reduce UE power consumption. The UE 115 may input measurements for a first set of beams to a machine learning model, and the machine learning model may output information or identifiers corresponding to a predicted second set of beams. A UE may be able to predict a direction or receive beam configuration for a predicted downlink beam.

In some examples, the UE 115 may perform non-codebook-based spatial domain prediction. The UE 115 may input information associated with a wireless channel or a set of beams into a machine learning model, and the machine learning model may output information associated with a point and direction, an angle-of-arrival, or an angle-of-departure. For example, for downlink spatial domain prediction, the machine learning model may output an angle-of-arrival from the network entity 105 or an angle-of-departure to the network entity 105.

In some examples, for downlink beam prediction, prediction targets may not be indicated. For example, the UE 115 may predict RSRPs for narrow beams based on UE-measured or UE-reported RSRPs for SSBs transmitted through wide beams. When predicting downlink beams, or virtual downlink beams or directions, the associated receive beam may also be predicted by the UE 115. The associated receive beam may be used for downlink transmission if the UE 115 is capable of beam correspondence.

However, in some systems, beam correspondence only has thresholds and conditions based on actual measurements. When the corresponding downlink beams are not actually transmitted, but the UE 115 instead predicts channel characteristics or signal characteristics for the downlink beams or directions, the thresholds and conditions for the actual measurements may not be usable. Therefore, the conditions to perform beam correspondence of these systems do not support beam correspondence using beam prediction.

The wireless communications system 100 supports techniques to perform beam correspondence based on beam predictions. Devices in the wireless communications system 100, such as UEs 115, may use beam correspondence requirements considering the case where the UE 115 predicts downlink beams and corresponding receive beams. In some examples, beam correspondence requirements may be fulfilled based on predicted signal characteristics or channel characteristics. For example, if a predicted measurement for a predicted downlink receive beam satisfies a threshold, the UE 115 may satisfy a side condition for beam correspondence using beam prediction.

The wireless communications system 100 may support techniques for beam correspondence requirements based on virtual resources, angle-of-arrivals, or angle-of-departures. For example, the UE 115 may predict a measurement for a virtual resource or an angle-of-arrival from the network entity 105. In some examples, the virtual resource or angle-of-arrival may not correspond to an actual beam of the network entity 105. However, the UE 115 may determine a measurement prediction for the virtual resource or direction and a corresponding receive beam for the virtual resource or direction. If the measurement prediction for the virtual resource satisfies a threshold, the UE 115 may meet the side conditions of prediction-based beam correspondence for the virtual resource.

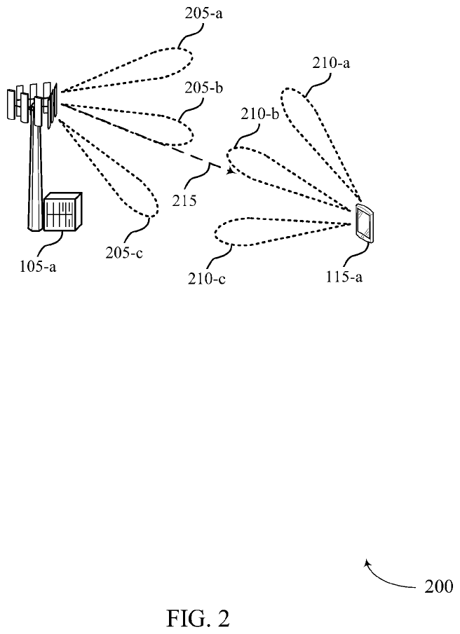

FIG. 2 shows an example of a wireless communications system 200 that supports beam correspondence conditions with joint beam pair prediction in accordance with one or more aspects of the present disclosure. The wireless communications system 200 may include some aspects of the wireless communications system 100 as described with reference to FIG. 1. The wireless communications system 200 may include a UE 115-a and a network entity 105-a, which may be respective examples of a UE 115 and a network entity 105 described herein. The UE 115-a and the network entity 105-a may communicate using beamformed communications. For example, the network entity 105-a may communicate using a network entity beam 205-a, a network entity beam 205-b, or a network entity beam 205-c, or any combination thereof. The UE 115-a may communicate using a UE beam 210-a, a UE beam 210-b, or a UE beam 210-c, or any combination thereof.

The UE 115-a and the network entity 105-a may support techniques for beam correspondence using joint beam prediction. The UE 115-a may be configured with conditions, or side conditions, to use beam correspondence to select an uplink transmit beam based on a predicted downlink receive beam. The UE 115-a may satisfy a beam correspondence requirement based on beam prediction if requirements, or conditions, for peak EIRP and spherical coverage are satisfied and the side conditions based on beam prediction are satisfied. For example, if the UE 115-a supports, or indicates a UE capability to support, beam correspondence without uplink beam sweeping, the UE 115-a may need to meet a minimum peak EIRP requirement and spherical coverage requirement in order to apply beam correspondence. If the UE 115-a does not support, or does not indicate a capability to support, beam correspondence without uplink beam sweeping, the UE 115-a may need to meet the minimum peak EIRP requirement, the spherical coverage requirement, meet a beam correspondence tolerance requirement, and support uplink beam management. In some examples, the thresholds described herein are referred to as conditions or requirements interchangeably.

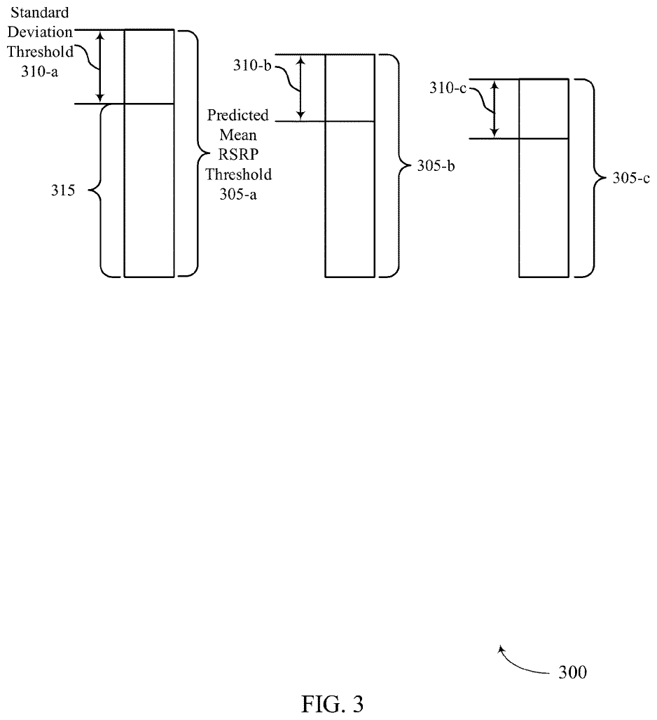

In some examples, the UE 115-a may be configured with side conditions for applying beam correspondence based on predicted beams, predicted virtual resources, or predicted angles-of-departure or predicted angles-of-arrival. To apply beam correspondence based on beam prediction, the UE 115-a may need to meet predicted signal characteristic requirements (e.g., predicted RSRP measurement requirements) on corresponding signals. For example, predicted RSRP measurements of CSI-RSs or SSBs may need to satisfy an associated threshold. To apply beam correspondence based on virtual resource predictions, the UE 115-a may need to meet predicted signal characteristic requirements on virtual resources, angles-of-arrival, or angles-of-departure. For example, the predicted RSRP measurements of virtual resources may satisfy an associated threshold for the UE 115-a to use beam correspondence based on a predicted virtual resource. Some additional examples of the thresholds and the measurement predictions to satisfy the thresholds are described in more detail with reference to FIG. 3.

In some examples, the UE 115-a may be configured with one or more tables of thresholds for the side requirements. In some examples, the one or more tables of thresholds for the side requirements may be associated with predictions for actual beams. For example, for each radio frequency spectrum band or operating band (e.g., NR operating band), the UE 115-a may be configured with a corresponding one or more thresholds as side conditions for beam correspondence using predictions. For example, the UE 115-a may be configured with one or more tables of RSRP requirements for SSBs or CSI-RS, or both. In some examples, the one or more tables may include thresholds for a predicted mean RSRP and a confidence level associated with the predicted mean RSRP.

In some examples, the confidence level may be based on a standard deviation associated with the predicted mean RSRP. For example, if the standard deviation of the predicted mean RSRP is smaller than the threshold standard deviation, the UE 115-a may satisfy the confidence level condition. If the predicted mean RSRP of the predicted measurements is larger than the mean RSRP threshold, the UE 115-a may satisfy the predicted mean RSRP condition. In some examples, the UE 115-a may be configured with multiple thresholds. For example, there may be multiple sets of thresholds for a certain radio frequency spectrum band, each including a minimum predicted RSRP threshold and a confidence level threshold. In some examples, if the predicted RSRP measurements of the downlink receive beams satisfy at least one of the sets of thresholds, the UE 115-a may meet or satisfy the beam correspondence side requirements associated with beam prediction.

In some examples, the UE 115-a may be configured with a threshold based on the predicted mean RSRP and the confidence level. For example, each radio frequency spectrum band may have a corresponding threshold, and if a predicted RSRP measurement minus the standard deviation associated with the measurement prediction satisfies the threshold, the UE 115-a may meet or satisfy the side requirement for beam correspondence associated with beam prediction.

In some examples, the UE 115-a may be configured with side conditions or thresholds associated with beam prediction on virtual resources, angles-of-arrival, or angles-of-departure. The virtual resources may correspond to a beam pointing direction 215 or beam shape information that is not actually transmitted by the network entity 105-a. For example, the beam pointing direction 215 may be between two actually transmitted beams, such as the network entity beam 205-b and the network entity beam 205-c In some examples, the network entity 105-a may indicate the virtual resources, angles-of-arrival, or angles-of-departure as beam prediction targets, or the UE 115-a may report the virtual resources, angles-of-arrival, or angles-of-departure. The side requirements based on virtual resources, angles-of-arrival, or angles-of-departure may include, or be based on, predicted mean RSRPs and confidence levels associated with the predicted mean RSRPs.

For example, the UE 115-a may be configured with one or more tables of mean RSRP prediction thresholds and standard deviation thresholds associated with predictions for virtual resources, directions, angles-of-arrival, or angles-of-departure. Additionally, or alternatively, the UE 115-a may be configured with one or more tables of thresholds that are based on the mean RSRP predictions and standard deviations associated with the predictions, where the UE 115-a may satisfy the beam correspondence side condition if a mean RSRP prediction for a virtual resource minus the associated standard deviation prediction satisfies the threshold corresponding to the virtual resource.

The UE 115-a may transmit a control message indicating a capability of the UE 115-a to perform beam correspondence using beam pair prediction. For example, the UE 115-a may indicate a capability of the UE 115-a to perform beam correspondence without uplink beam sweeping using predictions. In some examples, the UE 115-a may transmit the control message including a parameter or a field for a parameter, such as beamCorrespondenceWithoutUL-BeamSweeping-Prediction. In some examples, the capability to perform beam correspondence based on predictions may be transmitted in addition to, or as an alternative to, the capability to perform beam correspondence based on actual measurements.

In some examples, the UE 115-a may indicate a capability associated with beam correspondence based on beam prediction of actual beams. For example, the UE 115-a may indicate a capability to perform beam correspondence using SSB-based beam prediction or a capability to perform beam correspondence using CSI-RS-based beam prediction, or both. If the UE supports beam correspondence without uplink beam sweeping using prediction, and the UE supports either the capability to perform beam correspondence using SSB-based beam prediction or the capability to perform beam correspondence using CSI-RS-based beam prediction, the UE may need to meet the minimum peak EIRP requirements, the spherical coverage requirements, and the predicted RSRP requirements on SSBs or CSI-RS, respectively, to fulfill the beam correspondence requirements. If the UE does not support beam correspondence without uplink beam sweeping using prediction, but the UE does support either the capability to perform beam correspondence using SSB-based beam prediction or the capability to perform beam correspondence using CSI-RS-based beam prediction, the UE may need to meet the minimum peak EIRP requirements, the spherical coverage requirements with beam sweeping, meet beam correspondence tolerance requirements, support uplink beam management, and satisfy the predicted RSRP requirements on SSBs or CSI-RS, respectively, to fulfill the beam correspondence requirements. In some other examples, the UE 115-a may need to meet one or more of the requirements to fulfill the beam correspondence requirements.

In some examples, the UE 115-a may indicate a capability to perform beam correspondence using virtual resource-based prediction, a capability to perform beam correspondence using angle-of-arrival-based prediction, or a capability to perform beam correspondence using angle-of-departure-based prediction, or any combination thereof. If the UE supports beam correspondence without uplink beam sweeping using prediction, and the UE supports a capability to perform beam correspondence using virtual resources, angles-of-arrival, or angles-of-departure predictions, the UE may need to meet the minimum peak EIRP requirements, the spherical coverage requirements, and the predicted RSRP requirements on virtual resources, angles-of-arrival, or angles-of-departure, respectively, to fulfill the beam correspondence requirements. If the UE does not support beam correspondence without uplink beam sweeping using prediction, but the UE does support the capability to perform beam correspondence using virtual resources, angles-of-arrival, or angles-of-departure predictions, the UE may need to meet the minimum peak EIRP requirements, the spherical coverage requirements with beam sweeping, meet beam correspondence tolerance requirements, support uplink beam management, and satisfy the predicted RSRP requirements on virtual resources, angles-of-arrival, or angles-of-departure predictions, respectively, to fulfill the beam correspondence requirements. In some other examples, the UE 115-a may need to meet one or more of the requirements to fulfill the beam correspondence requirements.

In an example, the UE 115-a may transmit a control message indicating a capability of the UE 115-a to support beam correspondence without uplink beam sweeping using prediction and to support beam correspondence using CSI-RS-based beam predictions. The UE 115-a may receive CSI-RS using a first set of one or more downlink receive beams. The network entity 105-a may transmit the CSI-RS using a first set of one or more downlink transmit beams. The UE 115-a may measure the CSI-RS to obtain RSRP measurements for the first set of one or more downlink transmit beams. The UE 115-a may input channel characteristics or signal characteristics for the first set of one or more downlink transmit beams into a machine learning model to predict channel characteristics for a second set of one or more downlink transmit beams. For example, the UE 115-a may perform a prediction procedure to obtain a first set of predicted channel characteristics, such as predicted RSRP measurements, for a set of one or more predicted downlink transmit beams. In some examples, the UE 115-a may perform multiple predictions to obtain multiple RSRP predictions for the set of one or more predicted downlink transmit beams.

The UE 115-a may compare the predicted channel characteristics to a set of one or more thresholds to determine whether the UE 115-a satisfies the side conditions for beam correspondence based on beam prediction. For example, the UE 115-a may determine whether a mean RSRP prediction for a predicted downlink transmit beam satisfies a threshold associated with a radio frequency spectrum band of the predicted downlink transmit beam. Additionally, or alternatively, the UE 115-a may determine whether a standard deviation of the mean RSRP prediction satisfies a threshold associated with the prediction. If the mean RSRP prediction satisfies the threshold associated with the radio frequency spectrum band, and the standard deviation satisfies the threshold associated with the prediction, the UE 115-a may satisfy the side conditions for beam correspondence based on CSI-RS beam prediction. If the UE 115-a satisfies the other conditions for performing beam correspondence (e.g., the EIRP conditions and the spherical coverage requirements), the UE 115-a may use beam correspondence to identify, or select, a predicted uplink transmit beam based on a predicted downlink receive beam used for the predicted downlink transmit beam.

FIG. 3 shows an example of beam correspondence thresholds 300 that supports beam correspondence conditions with joint beam pair prediction in accordance with one or more aspects of the present disclosure.

A UE 115 that supports beam correspondence based on beam prediction may use machine learning or artificial intelligence to obtain signal characteristic predictions for one or more predicted downlink transmit beams. In some examples, the UE 115 may generate multiple predicted measurements for a predicted downlink transmit beam. In some examples, the predicted measurements may be predicted RSRP measurements or predicted SNR measurements. Additionally, or alternatively, the UE 115 may predict other signal characteristics or channel characteristics. The UE 115 may average, or take a mean of, the multiple predicted measurements to obtain a predicted mean RSRP. In some examples, the UE 115 may generate multiple predicted mean RSRPs. In some examples, the UE 115 may also identify a standard deviation of the predicted mean RSRP.

In some examples, the UE 115 may determine whether a predicted mean RSRP and the standard deviation for a predicted downlink transmit beam satisfy a threshold or side condition for using beam correspondence based on beam prediction. For example, the UE 115 may be configured with a table of thresholds for multiple downlink transmit beams. In some examples, the table may include thresholds associated with a downlink transmit beam, associated with a radio frequency spectrum band, or associated with an NR operating band. For example, the network entity 105 may have multiple beams on a radio frequency spectrum band, and each of the multiple downlink transmit beams may have a same set of thresholds based on being on the same radio frequency spectrum band.

In some examples, the UE 115 may need to satisfy both a predicted mean RSRP requirement and a confidence requirement to satisfy requirements or conditions for using beam correspondence based on prediction. The confidence level requirement may be based on the standard deviation of an RSRP prediction. The UE 115 may compare the predicted mean RSRP for the predicted downlink transmit beam to a predicted mean RSRP threshold 305 associated with the predicted downlink transmit beam or associated with a radio frequency spectrum band of the predicted downlink transmit beam. Additionally, or alternatively, the UE 115 may compare the standard deviation of the predicted mean RSRP to a standard deviation threshold 310 associated with the predicted downlink transmit beam or associated with the radio frequency spectrum band of the predicted downlink transmit beam. If the mean predicted RSRP is greater than the predicted mean RSRP threshold 305 and the standard deviation is less than the standard deviation threshold 310, the UE 115 may satisfy the beam correspondence side conditions. In some examples, the predicted mean RSRP threshold 305 may be a minimum predicted mean RSRP threshold, and the standard deviation threshold 310 may be a maximum standard deviation threshold.

In some examples, the UE 115 may be configured with multiple sets of thresholds for each radio frequency spectrum band or operating band. For example, a first radio frequency spectrum band may have three pairs of thresholds or requirements, each pair including a predicted mean RSRP threshold 305 and a corresponding standard deviation threshold 310. For example, the first radio frequency spectrum band may have a predicted mean RSRP threshold 305-a and a corresponding standard deviation threshold 310-a, a predicted mean RSRP threshold 305-b and a corresponding standard deviation threshold 310-b, and a predicted mean RSRP threshold 305-c and a corresponding standard deviation threshold 310-c. In some examples, the UE 115 may meet the requirements for performing beam correspondence using predictions if the predicted mean RSRP and the standard deviation of the predicted mean RSRP satisfy any one of the pairs of thresholds. For example if the predicted mean RSRP is greater than the predicted mean RSRP threshold 305-a and the associated standard deviation is below the standard deviation threshold 310-a, the UE 115 may satisfy the beam correspondence side requirements. Or, if the predicted mean RSRP is greater than the predicted mean RSRP threshold 305-b and the associated standard deviation is below the standard deviation threshold 310-b, the UE 115 may satisfy the beam correspondence side requirements.

In some examples, the thresholds or requirements may be based on a difference between the predicted mean RSRP and the standard deviation of the prediction. For example, a threshold 315 may be based on a lower bound of the RSRP, using the predicted mean RSRP and the associated confidence level or standard deviation. For example, if a difference between the predicted mean RSRP and the standard deviation associated with the predicted mean RSRP satisfies the threshold 315, the UE 115 may satisfy the beam correspondence side requirements.

While these examples correspond to beam correspondence based on predictions of actual beams, the UE 115 may be similarly configured with thresholds, or tables of thresholds, associated with virtual resources, angles-of-arrival, or angles-of-departure, or any combination thereof. For example, the UE 115 may predict a predicted mean RSRP associated with a virtual resource and identify a standard deviation associated with the predicted mean RSRP. The UE 115 may compare the predicted mean RSRP of the virtual resource to a predicted mean RSRP threshold 305 and compare the standard deviation associated with the prediction to a standard deviation threshold 310.

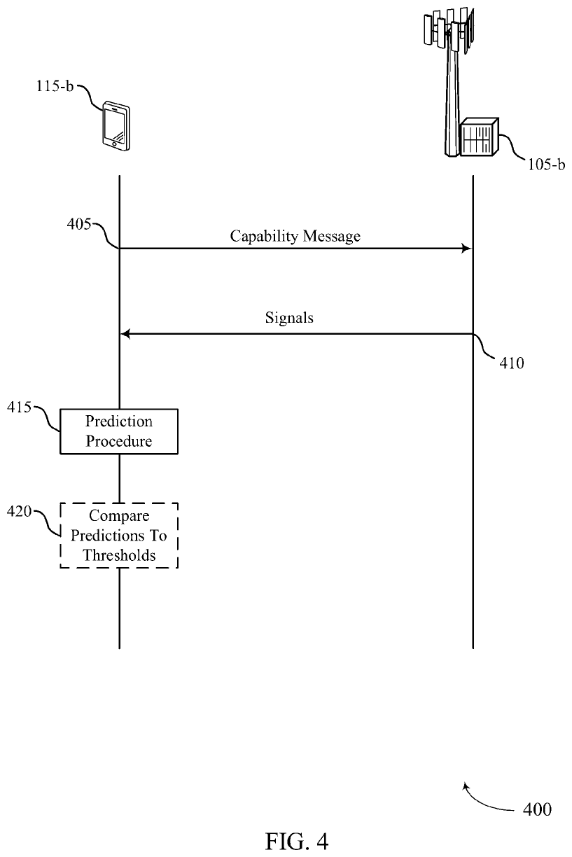

FIG. 4 shows an example of a process flow 400 that supports beam correspondence conditions with joint beam pair prediction in accordance with one or more aspects of the present disclosure. The process flow 400 may implement or be implemented by aspects of the wireless communications system 100, the wireless communications system 200, and the beam correspondence thresholds 300 as described with reference to FIGS. 1 through 3. For example, the process flow 400 may include a UE 115-b and a network entity 105-b, which may represent examples of corresponding devices described herein. The process flow 400 illustrates communications between the UE 115-b and the network entity 105-b to support beam correspondence using predictions.

In the following description of the process flow 400, the operations between the UE 115-b and the network entity 105-b may be performed in different orders or at different times. Some operations may also be left out of the process flow 400, or other operations may be added. Although the UE 115-b and the network entity 105-b are shown performing the operations of the process flow 400, some aspects of some operations may also be performed by one or more other wireless devices.

At 405, the UE 115-b may transmit a capability message to the network entity 105-b. For example, the UE 115-b may transmit a control message indicating a capability of the UE 115-b to support beam correspondence between a downlink receive beam and an uplink transmit beam using beam prediction. In some examples, the control message may indicate the capability of the UE 115-b to support the beam correspondence between the downlink receive beam and the uplink transmit beam using a CSI-RS or using an SSB, or both. Additionally, or alternatively, the control message may indicate the capability of the UE 115-b to support the beam correspondence between the downlink receive beam and the uplink transmit beam based at least in part on a virtual resource of the network entity, an angle of arrival, an angle of departure of the network entity, or any combination thereof.

At 410, the UE 115-b may receive, from the network entity 105-b, one or more signals. For example, the UE 115-b may measure the one or more signals using one or more downlink receive beams of the UE 115-b. In some examples, the one or more signals may be one or more SSBs or one or more CSI-RS, or both.

At 415, the UE 115-b may predict channel characteristics or signal characteristics for one or more beams based on measuring the one or more signals. For example, the UE 115-b may perform a prediction procedure for a predicted downlink receive beam of the UE and a predicted downlink transmit beam of a network entity.

The UE 115-b may compare the measurement predictions to a threshold or requirement associated with beam correspondence using predictions at 420. In some examples, the UE 115-b may be configured, or pre-configured, with a set of conditions, requirements, or thresholds for using beam correspondence based on predictions. In some examples, a radio frequency spectrum band, or an operating band such as an NR operating band, may have a corresponding set of thresholds for using beam correspondence based on predictions. If a predicted measurement for a predicted downlink transmit beam satisfies the thresholds associated with the radio frequency spectrum band of the predicted downlink transmit beam, the UE 115-b may meet or satisfy conditions to apply beam correspondence.

For example, the UE 115-b may compare a mean predicted RSRP of a predicted downlink transmit beam to a mean predicted RSRP threshold or compare a standard deviation associated with the prediction to a standard deviation threshold. The predicted downlink receive beam may correspond to a predicted uplink transmit beam based on one or more measurement predictions satisfying a threshold. In some examples, the UE 115-b may perform the prediction procedure to obtain a predicted reference signal measurement for the predicted downlink receive beam, and the predicted downlink receive beam may correspond to the predicted uplink transmit beam based on the predicted reference signal measurement satisfying a predicted reference signal measurement threshold. In some examples, the UE 115-b may perform the prediction procedure to obtain multiple predicted reference signal measurements for the predicted downlink receive beam, and the predicted downlink receive beam may correspond to the predicted uplink transmit beam based at least on a mean of the multiple predicted reference signal measurements satisfying a predicted reference signal measurement threshold.

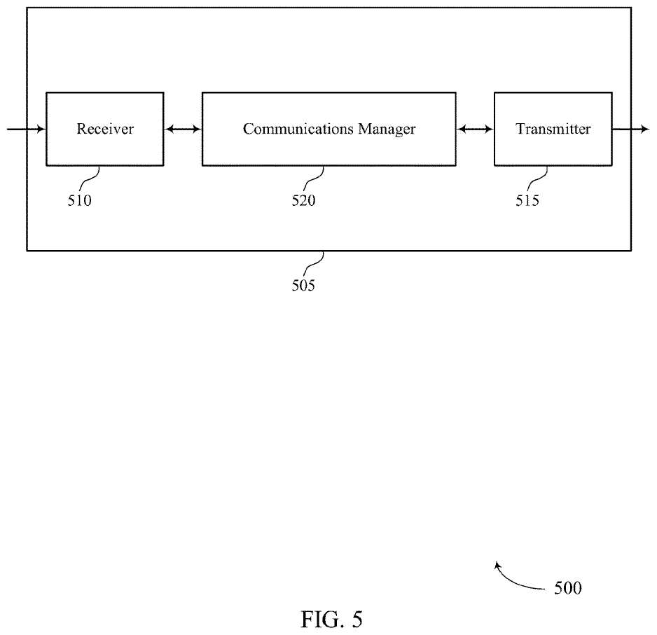

FIG. 5 shows a block diagram 500 of a device 505 that supports beam correspondence conditions with joint beam pair prediction in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to beam correspondence conditions with joint beam pair prediction).

Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to beam correspondence conditions with joint beam pair prediction). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of beam correspondence conditions with joint beam pair prediction as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a UE in accordance with examples as disclosed herein. For example, the communications manager 520 may be configured as or otherwise support a means for transmitting a control message indicating a capability of the UE to support beam correspondence between a downlink receive beam and an uplink transmit beam using beam prediction. The communications manager 520 may be configured as or otherwise support a means for measuring one or more signals using one or more downlink receive beams of the UE. The communications manager 520 may be configured as or otherwise support a means for performing a prediction procedure for a predicted downlink receive beam of the UE and a predicted downlink transmit beam of a network entity, where the predicted downlink receive beam corresponds to a predicted uplink transmit beam based on one or more measurement predictions satisfying a threshold.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for reduced processing by supporting beam correspondence for beam predictions, which may reduce measurements and beam training for an uplink transmit beam.

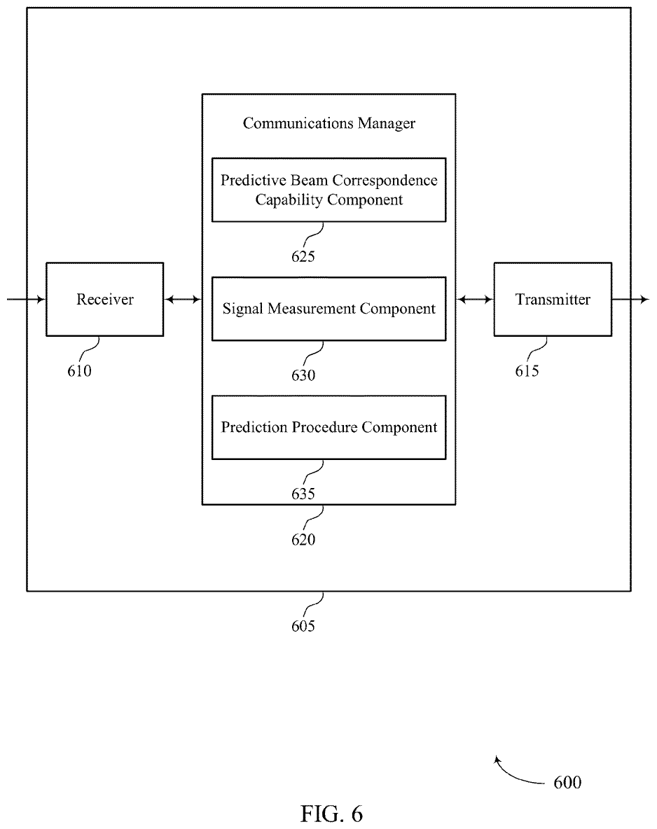

FIG. 6 shows a block diagram 600 of a device 605 that supports beam correspondence conditions with joint beam pair prediction in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to beam correspondence conditions with joint beam pair prediction).

Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to beam correspondence conditions with joint beam pair prediction). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of beam correspondence conditions with joint beam pair prediction as described herein. For example, the communications manager 620 may include a predictive beam correspondence capability component 625, a signal measurement component 630, a prediction procedure component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. The predictive beam correspondence capability component 625 may be configured as or otherwise support a means for transmitting a control message indicating a capability of the UE to support beam correspondence between a downlink receive beam and an uplink transmit beam using beam prediction. The signal measurement component 630 may be configured as or otherwise support a means for measuring one or more signals using one or more downlink receive beams of the UE. The prediction procedure component 635 may be configured as or otherwise support a means for performing a prediction procedure for a predicted downlink receive beam of the UE and a predicted downlink transmit beam of a network entity, where the predicted downlink receive beam corresponds to a predicted uplink transmit beam based on one or more measurement predictions satisfying a threshold.

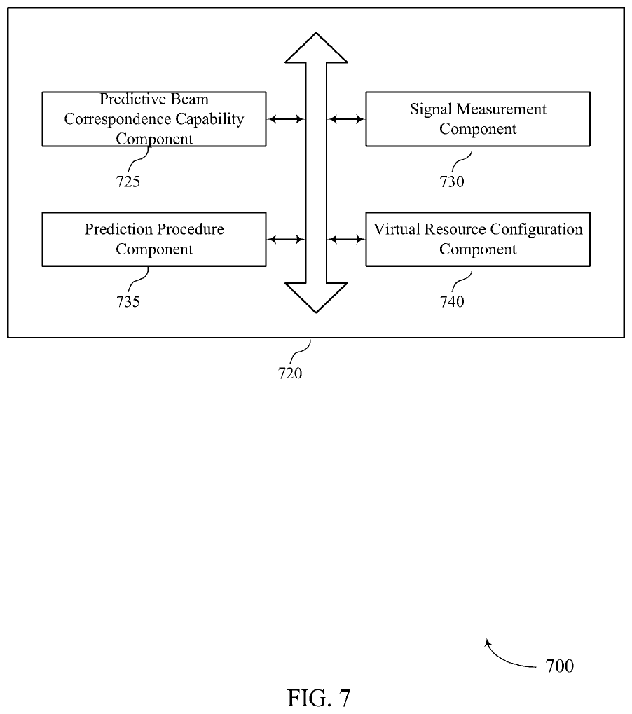

FIG. 7 shows a block diagram 700 of a communications manager 720 that supports beam correspondence conditions with joint beam pair prediction in accordance with one or more aspects of the present disclosure. The communications manager 720 may be an example of aspects of a communications manager 520, a communications manager 620, or both, as described herein. The communications manager 720, or various components thereof, may be an example of means for performing various aspects of beam correspondence conditions with joint beam pair prediction as described herein. For example, the communications manager 720 may include a predictive beam correspondence capability component 725, a signal measurement component 730, a prediction procedure component 735, a virtual resource configuration component 740, or any combination thereof. Each of these components may communicate, directly or indirectly, with one another (e.g., via one or more buses).

The communications manager 720 may support wireless communications at a UE in accordance with examples as disclosed herein. The predictive beam correspondence capability component 725 may be configured as or otherwise support a means for transmitting a control message indicating a capability of the UE to support beam correspondence between a downlink receive beam and an uplink transmit beam using beam prediction. The signal measurement component 730 may be configured as or otherwise support a means for measuring one or more signals using one or more downlink receive beams of the UE. The prediction procedure component 735 may be configured as or otherwise support a means for performing a prediction procedure for a predicted downlink receive beam of the UE and a predicted downlink transmit beam of a network entity, where the predicted downlink receive beam corresponds to a predicted uplink transmit beam based on one or more measurement predictions satisfying a threshold.

In some examples, to support performing the prediction procedure, the prediction procedure component 735 may be configured as or otherwise support a means for performing the prediction procedure to obtain a predicted reference signal measurement for the predicted downlink receive beam, where the predicted downlink receive beam corresponds to the predicted uplink transmit beam based on the predicted reference signal measurement satisfying a predicted reference signal measurement threshold.

In some examples, the predicted reference signal measurement is based on a mean of a set of multiple predicted reference signal measurements for the predicted downlink receive beam.

In some examples, to support performing the prediction procedure, the prediction procedure component 735 may be configured as or otherwise support a means for performing the prediction procedure to obtain a set of multiple predicted reference signal measurements for the predicted downlink receive beam, where the predicted downlink receive beam corresponds to the predicted uplink transmit beam based on at least one predicted reference signal measurement of the set of multiple predicted reference signal measurements satisfying a predicted reference signal measurement threshold.

In some examples, to support performing the prediction procedure, the prediction procedure component 735 may be configured as or otherwise support a means for performing the prediction procedure to obtain a confidence metric associated with the one or more measurement predictions, where the predicted downlink receive beam corresponds to the predicted uplink transmit beam based on the confidence metric satisfying a confidence metric threshold.

In some examples, the confidence metric is associated with a standard deviation of a mean for the one or more measurement predictions.

In some examples, to support performing the prediction procedure, the prediction procedure component 735 may be configured as or otherwise support a means for performing the prediction procedure to obtain the one or more measurement predictions associated with a radio frequency spectrum band, where the threshold is associated with the radio frequency spectrum band.

In some examples, to support performing the prediction procedure, the prediction procedure component 735 may be configured as or otherwise support a means for performing the prediction procedure to obtain the one or more measurement predictions associated with a beam direction from the network entity, where the threshold is associated with the beam direction from the network entity.

In some examples, to support performing the prediction procedure, the prediction procedure component 735 may be configured as or otherwise support a means for performing the prediction procedure to obtain a predicted measurement for a spatial resource associated with the predicted downlink transmit beam and the predicted downlink receive beam, where the predicted downlink receive beam corresponds to the predicted uplink transmit beam based on the predicted measurement for the spatial resource satisfying the threshold.

In some examples, the predicted measurement for the spatial resource is based on a mean of a set of multiple predicted measurements for the spatial resource.

In some examples, the spatial resource is a virtual resource of the network entity.

In some examples, the spatial resource is associated with an angle of arrival at the network entity or an angle of departure from the network entity, or both.

In some examples, to support performing the prediction procedure, the prediction procedure component 735 may be configured as or otherwise support a means for performing the prediction procedure to obtain a set of multiple predicted measurements for a spatial resource associated with the predicted downlink transmit beam and the predicted downlink receive beam, where the predicted downlink receive beam corresponds to the predicted uplink transmit beam based on at least one predicted measurement for the spatial resource of the set of multiple predicted measurements for the spatial resource satisfying the threshold.

In some examples, the virtual resource configuration component 740 may be configured as or otherwise support a means for receiving control signaling indicating a set of multiple virtual resources of the network entity, where at least the predicted downlink transmit beam is associated with a virtual resource of the set of multiple virtual resources.

In some examples, the control signaling identifies a beam shape or beam pointing direction associated with each virtual resource of the set of multiple virtual resources.

In some examples, to support measuring the one or more signals, the signal measurement component 730 may be configured as or otherwise support a means for measuring a channel state information reference signal or a synchronization signal block, or both, where the one or more measurement predictions are associated with measuring the channel state information reference signal or measuring the synchronization signal block, or both.

In some examples, to support transmitting the control message, the predictive beam correspondence capability component 725 may be configured as or otherwise support a means for transmitting the control message indicating the capability of the UE to support the beam correspondence between the downlink receive beam and the uplink transmit beam using a channel state information reference signal or using a synchronization signal block, or both.

In some examples, to support transmitting the control message, the predictive beam correspondence capability component 725 may be configured as or otherwise support a means for transmitting the control message indicating the capability of the UE to support the beam correspondence between the downlink receive beam and the uplink transmit beam based on a virtual resource of the network entity, an angle of arrival, an angle of departure of the network entity, or any combination thereof.

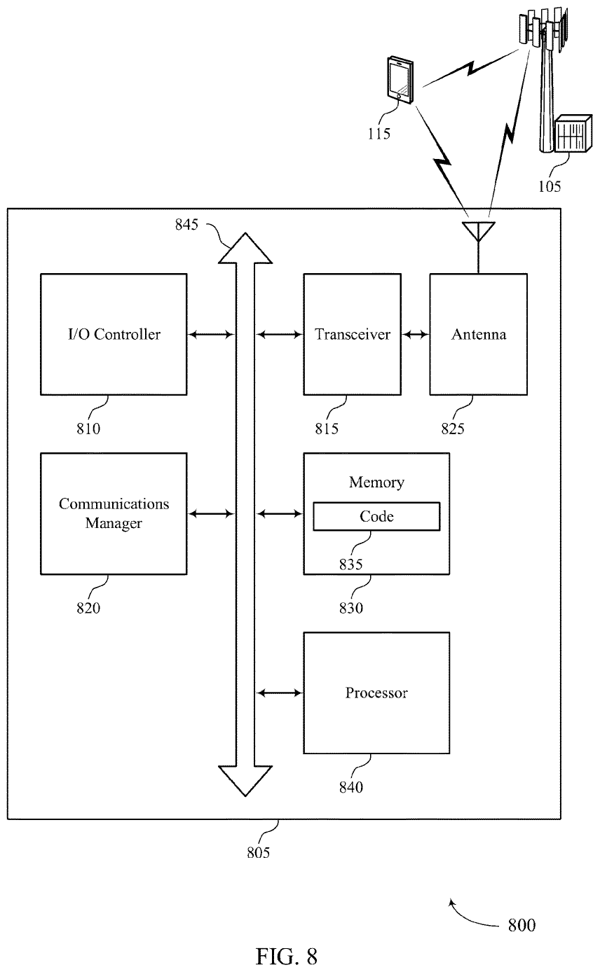

FIG. 8 shows a diagram of a system 800 including a device 805 that supports beam correspondence conditions with joint beam pair prediction in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting beam correspondence conditions with joint beam pair prediction). For example, the device 805 or a component of the device 805 may include a processor 840 and memory 830 coupled with or to the processor 840, the processor 840 and memory 830 configured to perform various functions described herein.

The communications manager 820 may support wireless communications at a UE in accordance with examples as disclosed herein. For example, the communications manager 820 may be configured as or otherwise support a means for transmitting a control message indicating a capability of the UE to support beam correspondence between a downlink receive beam and an uplink transmit beam using beam prediction. The communications manager 820 may be configured as or otherwise support a means for measuring one or more signals using one or more downlink receive beams of the UE. The communications manager 820 may be configured as or otherwise support a means for performing a prediction procedure for a predicted downlink receive beam of the UE and a predicted downlink transmit beam of a network entity, where the predicted downlink receive beam corresponds to a predicted uplink transmit beam based on one or more measurement predictions satisfying a threshold.

By including or configuring the communications manager 820 in accordance with examples as described herein, the device 805 may support techniques for reduced processing by supporting beam correspondence for beam predictions, which may reduce measurements and beam training for an uplink transmit beam.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of beam correspondence conditions with joint beam pair prediction as described herein, or the processor 840 and the memory 830 may be otherwise configured to perform or support such operations.

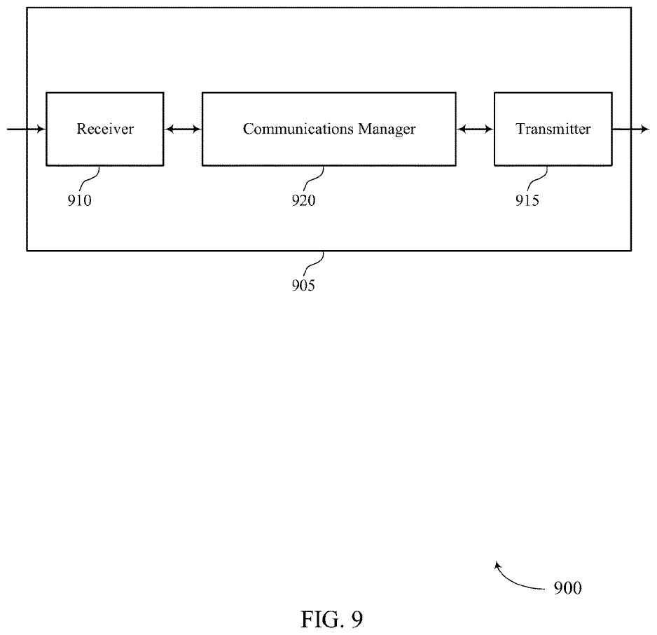

FIG. 9 shows a block diagram 900 of a device 905 that supports beam correspondence conditions with joint beam pair prediction in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of beam correspondence conditions with joint beam pair prediction as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a network entity in accordance with examples as disclosed herein. For example, the communications manager 920 may be configured as or otherwise support a means for receiving a control message indicating a capability of a UE to support beam correspondence between a downlink receive beam and an uplink transmit beam using beam prediction. The communications manager 920 may be configured as or otherwise support a means for transmitting one or more signals using one or more downlink transmit beams of the network entity based on the capability of the UE to support beam correspondence between the downlink receive beam and the uplink transmit beam using beam prediction.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for reduced processing and reduced power consumption by supporting beam correspondence for beam predictions, which may reduce measurements and beam training for an uplink transmit beam.

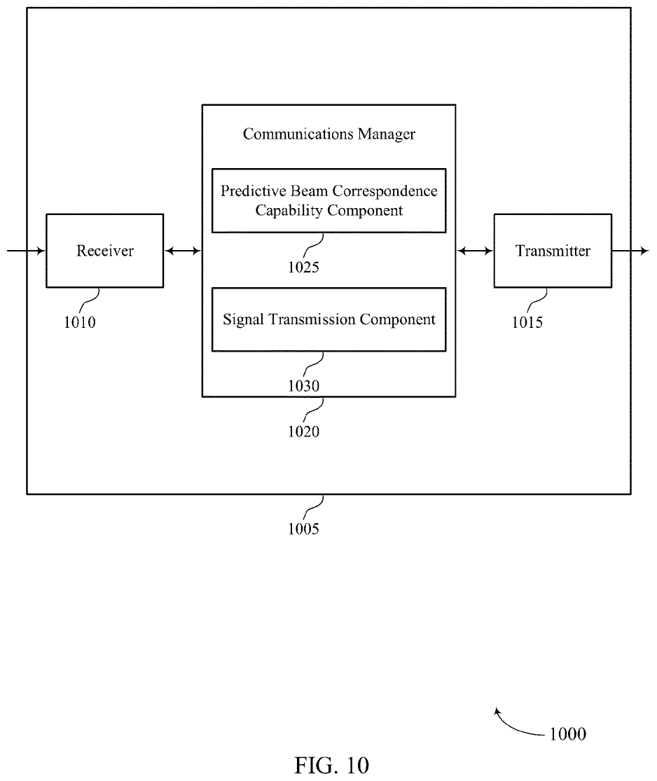

FIG. 10 shows a block diagram 1000 of a device 1005 that supports beam correspondence conditions with joint beam pair prediction in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of beam correspondence conditions with joint beam pair prediction as described herein. For example, the communications manager 1020 may include a predictive beam correspondence capability component 1025 a signal transmission component 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network entity in accordance with examples as disclosed herein. The predictive beam correspondence capability component 1025 may be configured as or otherwise support a means for receiving a control message indicating a capability of a UE to support beam correspondence between a downlink receive beam and an uplink transmit beam using beam prediction. The signal transmission component 1030 may be configured as or otherwise support a means for transmitting one or more signals using one or more downlink transmit beams of the network entity based on the capability of the UE to support beam correspondence between the downlink receive beam and the uplink transmit beam using beam prediction.

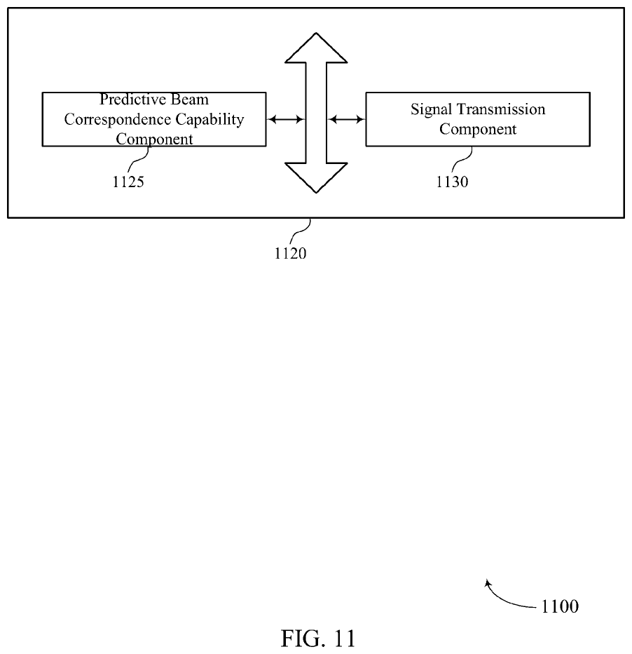

FIG. 11 shows a block diagram 1100 of a communications manager 1120 that supports beam correspondence conditions with joint beam pair prediction in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of beam correspondence conditions with joint beam pair prediction as described herein. For example, the communications manager 1120 may include a predictive beam correspondence capability component 1125 a signal transmission component 1130, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications at a network entity in accordance with examples as disclosed herein. The predictive beam correspondence capability component 1125 may be configured as or otherwise support a means for receiving a control message indicating a capability of a UE to support beam correspondence between a downlink receive beam and an uplink transmit beam using beam prediction. The signal transmission component 1130 may be configured as or otherwise support a means for transmitting one or more signals using one or more downlink transmit beams of the network entity based on the capability of the UE to support beam correspondence between the downlink receive beam and the uplink transmit beam using beam prediction.

In some examples, to support receiving the control message, the predictive beam correspondence capability component 1125 may be configured as or otherwise support a means for receiving the control message indicating the capability of the UE to support the beam correspondence between the downlink receive beam and the uplink transmit beam using a channel state information reference signal or using a synchronization signal block, or both.

In some examples, to support receiving the control message, the predictive beam correspondence capability component 1125 may be configured as or otherwise support a means for receiving the control message indicating the capability of the UE to support the beam correspondence between the downlink receive beam and the uplink transmit beam based on a virtual resource of the network entity, an angle of arrival, an angle of departure of the network entity, or any combination thereof.

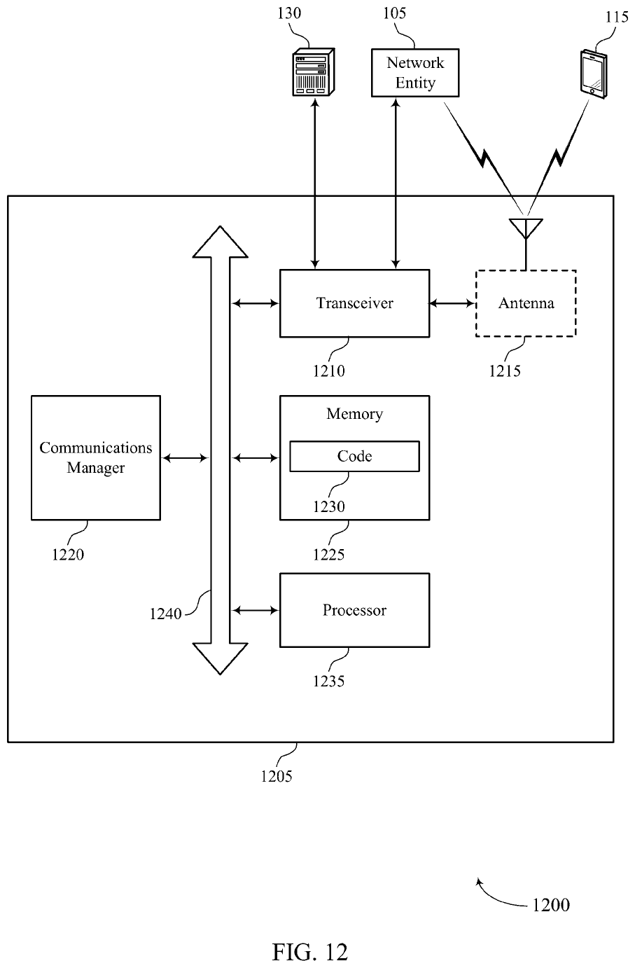

FIG. 12 shows a diagram of a system 1200 including a device 1205 that supports beam correspondence conditions with joint beam pair prediction in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting beam correspondence conditions with joint beam pair prediction). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225). In some implementations, the processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications at a network entity in accordance with examples as disclosed herein. For example, the communications manager 1220 may be configured as or otherwise support a means for receiving a control message indicating a capability of a UE to support beam correspondence between a downlink receive beam and an uplink transmit beam using beam prediction. The communications manager 1220 may be configured as or otherwise support a means for transmitting one or more signals using one or more downlink transmit beams of the network entity based on the capability of the UE to support beam correspondence between the downlink receive beam and the uplink transmit beam using beam prediction.

By including or configuring the communications manager 1220 in accordance with examples as described herein, the device 1205 may support techniques for reduced processing and reduced power consumption by supporting beam correspondence for beam predictions, which may reduce measurements and beam training for an uplink transmit beam.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, the processor 1235, the memory 1225, the code 1230, or any combination thereof. For example, the code 1230 may include instructions executable by the processor 1235 to cause the device 1205 to perform various aspects of beam correspondence conditions with joint beam pair prediction as described herein, or the processor 1235 and the memory 1225 may be otherwise configured to perform or support such operations.

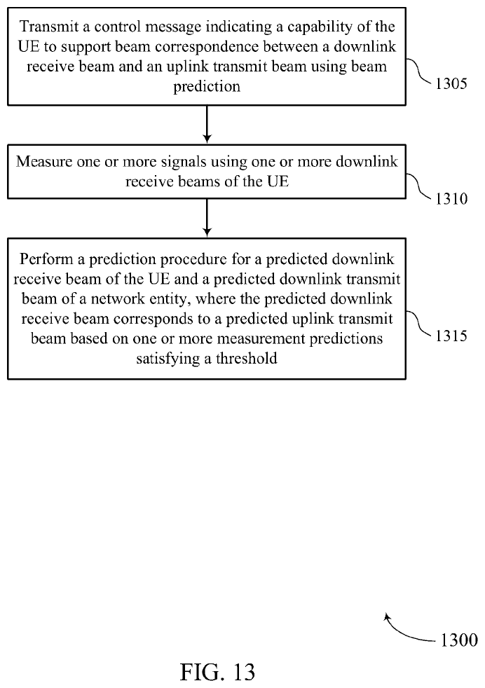

FIG. 13 shows a flowchart illustrating a method 1300 that supports beam correspondence conditions with joint beam pair prediction in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include transmitting a control message indicating a capability of the UE to support beam correspondence between a downlink receive beam and an uplink transmit beam using beam prediction. The operations of 1305 may be performed in accordance with examples as disclosed herein. In some examples, aspects of the operations of 1305 may be performed by a predictive beam correspondence capability component 725 as described with reference to FIG. 7.

At 1310, the method may include measuring one or more signals using one or more downlink receive beams of the UE. The operations of 1310 may be performed in accordance with examples as disclosed herein. In some examples, aspects of the operations of 1310 may be performed by a signal measurement component 730 as described with reference to FIG. 7.

At 1315, the method may include performing a prediction procedure for a predicted downlink receive beam of the UE and a predicted downlink transmit beam of a network entity, where the predicted downlink receive beam corresponds to a predicted uplink transmit beam based on one or more measurement predictions satisfying a threshold. The operations of 1315 may be performed in accordance with examples as disclosed herein. In some examples, aspects of the operations of 1315 may be performed by a prediction procedure component 735 as described with reference to FIG. 7.

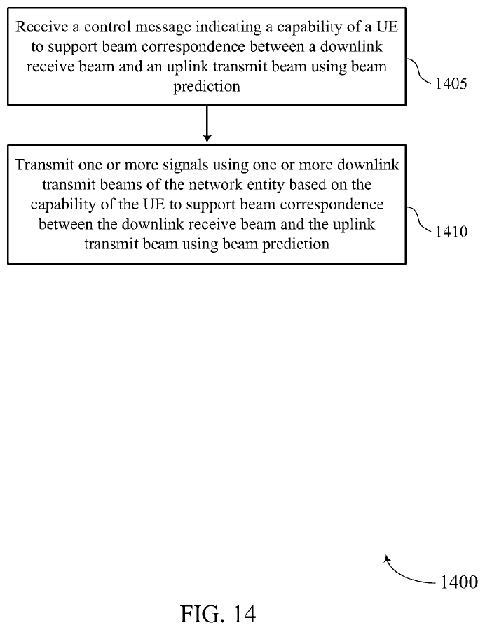

FIG. 14 shows a flowchart illustrating a method 1400 that supports beam correspondence conditions with joint beam pair prediction in accordance with one or more aspects of the present disclosure. The operations of the method 1400 may be implemented by a network entity or its components as described herein. For example, the operations of the method 1400 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1405, the method may include receiving a control message indicating a capability of a UE to support beam correspondence between a downlink receive beam and an uplink transmit beam using beam prediction. The operations of 1405 may be performed in accordance with examples as disclosed herein. In some examples, aspects of the operations of 1405 may be performed by a predictive beam correspondence capability component 1125 as described with reference to FIG. 11.

At 1410, the method may include transmitting one or more signals using one or more downlink transmit beams of the network entity based on the capability of the UE to support beam correspondence between the downlink receive beam and the uplink transmit beam using beam prediction. The operations of 1410 may be performed in accordance with examples as disclosed herein. In some examples, aspects of the operations of 1410 may be performed by a signal transmission component 1130 as described with reference to FIG. 11.

The following provides an overview of aspects of the present disclosure:

Aspect 1: A method for wireless communications at a UE, comprising: transmitting a control message indicating a capability of the UE to support beam correspondence between a downlink receive beam and an uplink transmit beam using beam prediction; measuring one or more signals using one or more downlink receive beams of the UE; and performing a prediction procedure for a predicted downlink receive beam of the UE and a predicted downlink transmit beam of a network entity, wherein the predicted downlink receive beam corresponds to a predicted uplink transmit beam based at least in part on one or more measurement predictions satisfying a threshold.

Aspect 2: The method of aspect 1, wherein performing the prediction procedure comprises: performing the prediction procedure to obtain a predicted reference signal measurement for the predicted downlink receive beam, wherein the predicted downlink receive beam corresponds to the predicted uplink transmit beam based at least in part on the predicted reference signal measurement satisfying a predicted reference signal measurement threshold.

Aspect 3: The method of aspect 2, wherein the predicted reference signal measurement is based at least in part on a mean of a plurality of predicted reference signal measurements for the predicted downlink receive beam.

Aspect 4: The method of any of aspects 1 through 3, wherein performing the prediction procedure comprises: performing the prediction procedure to obtain a plurality of predicted reference signal measurements for the predicted downlink receive beam, wherein the predicted downlink receive beam corresponds to the predicted uplink transmit beam based at least in part on at least one predicted reference signal measurement of the plurality of predicted reference signal measurements satisfying a predicted reference signal measurement threshold.

Aspect 5: The method of any of aspects 1 through 4, wherein performing the prediction procedure comprises: performing the prediction procedure to obtain a confidence metric associated with the one or more measurement predictions, wherein the predicted downlink receive beam corresponds to the predicted uplink transmit beam based at least in part on the confidence metric satisfying a confidence metric threshold.

Aspect 6: The method of aspect 5, wherein the confidence metric is associated with a standard deviation of a mean for the one or more measurement predictions.

Aspect 7: The method of any of aspects 1 through 6, wherein performing the prediction procedure comprises: performing the prediction procedure to obtain the one or more measurement predictions associated with a radio frequency spectrum band, wherein the threshold is associated with the radio frequency spectrum band.

Aspect 8: The method of any of aspects 1 through 7, wherein performing the prediction procedure comprises: performing the prediction procedure to obtain the one or more measurement predictions associated with a beam direction from the network entity, wherein the threshold is associated with the beam direction from the network entity.

Aspect 9: The method of any of aspects 1 through 8, wherein performing the prediction procedure comprises: performing the prediction procedure to obtain a predicted measurement for a spatial resource associated with the predicted downlink transmit beam and the predicted downlink receive beam, wherein the predicted downlink receive beam corresponds to the predicted uplink transmit beam based at least in part on the predicted measurement for the spatial resource satisfying the threshold.

Aspect 10: The method of aspect 9, wherein the predicted measurement for the spatial resource is based at least in part on a mean of a plurality of predicted measurements for the spatial resource.

Aspect 11: The method of any of aspects 9 through 10, wherein the spatial resource is a virtual resource of the network entity.

Aspect 12: The method of any of aspects 9 through 11, wherein the spatial resource is associated with an angle of arrival at the network entity or an angle of departure from the network entity, or both.

Aspect 13: The method of any of aspects 1 through 12, wherein performing the prediction procedure comprises: performing the prediction procedure to obtain a plurality of predicted measurements for a spatial resource associated with the predicted downlink transmit beam and the predicted downlink receive beam, wherein the predicted downlink receive beam corresponds to the predicted uplink transmit beam based at least in part on at least one predicted measurement for the spatial resource of the plurality of predicted measurements for the spatial resource satisfying the threshold.

Aspect 14: The method of any of aspects 1 through 13, further comprising: receiving control signaling indicating a plurality of virtual resources of the network entity, wherein at least the predicted downlink transmit beam is associated with a virtual resource of the plurality of virtual resources.

Aspect 15: The method of aspect 14, wherein the control signaling identifies a beam shape or beam pointing direction associated with each virtual resource of the plurality of virtual resources.

Aspect 16: The method of any of aspects 1 through 15, wherein measuring the one or more signals comprises: measuring a channel state information reference signal or a synchronization signal block, or both, wherein the one or more measurement predictions are associated with measuring the channel state information reference signal or measuring the synchronization signal block, or both.

Aspect 17: The method of any of aspects 1 through 16, wherein transmitting the control message comprises: transmitting the control message indicating the capability of the UE to support the beam correspondence between the downlink receive beam and the uplink transmit beam using a channel state information reference signal or using a synchronization signal block, or both.

Aspect 18: The method of any of aspects 1 through 17, wherein transmitting the control message comprises: transmitting the control message indicating the capability of the UE to support the beam correspondence between the downlink receive beam and the uplink transmit beam based at least in part on a virtual resource of the network entity, an angle of arrival, an angle of departure of the network entity, or any combination thereof.

Aspect 19: A method for wireless communications at a network entity, comprising: receiving a control message indicating a capability of a UE to support beam correspondence between a downlink receive beam and an uplink transmit beam using beam prediction; and transmitting one or more signals using one or more downlink transmit beams of the network entity based at least in part on the capability of the UE to support beam correspondence between the downlink receive beam and the uplink transmit beam using beam prediction.

Aspect 20: The method of aspect 19, wherein receiving the control message comprises: receiving the control message indicating the capability of the UE to support the beam correspondence between the downlink receive beam and the uplink transmit beam using a channel state information reference signal or using a synchronization signal block, or both.

Aspect 21: The method of any of aspects 19 through 20, wherein receiving the control message comprises: receiving the control message indicating the capability of the UE to support the beam correspondence between the downlink receive beam and the uplink transmit beam based at least in part on a virtual resource of the network entity, an angle of arrival, an angle of departure of the network entity, or any combination thereof.

Aspect 22: An apparatus for wireless communications at a UE, comprising a processor; memory coupled with the processor; and instructions stored in the memory and executable by the processor to cause the apparatus to perform a method of any of aspects 1 through 18.

Aspect 23: An apparatus for wireless communications at a UE, comprising at least one means for performing a method of any of aspects 1 through 18.

Aspect 24: A non-transitory computer-readable medium storing code for wireless communications at a UE, the code comprising instructions executable by a processor to perform a method of any of aspects 1 through 18.

Aspect 25: An apparatus for wireless communications at a network entity, comprising a processor; memory coupled with the processor; and instructions stored in the memory and executable by the processor to cause the apparatus to perform a method of any of aspects 19 through 21.

Aspect 26: An apparatus for wireless communications at a network entity, comprising at least one means for performing a method of any of aspects 19 through 21.

Aspect 27: A non-transitory computer-readable medium storing code for wireless communications at a network entity, the code comprising instructions executable by a processor to perform a method of any of aspects 19 through 21.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communications at a user equipment (UE), comprising:
a memory; and
a processor coupled to the memory and configured to:
transmit a control message indicating a capability of the UE to support beam correspondence between a downlink receive beam and an uplink transmit beam using beam prediction;
measure one or more signals using one or more downlink receive beams of the UE; and perform a prediction procedure for a predicted downlink receive beam of the UE and a predicted downlink transmit beam of a network entity, wherein the predicted downlink receive beam corresponds to a predicted uplink transmit beam based at least in part on one or more measurement predictions satisfying a threshold.

2. The apparatus of claim 1, wherein, to perform the prediction procedure, the processor is configured to:
perform the prediction procedure to obtain a predicted reference signal measurement for the predicted downlink receive beam, wherein the predicted downlink receive beam corresponds to the predicted uplink transmit beam based at least in part on the predicted reference signal measurement satisfying a predicted reference signal measurement threshold.

3. The apparatus of claim 2, wherein the predicted reference signal measurement is based at least in part on a mean of a plurality of predicted reference signal measurements for the predicted downlink receive beam.

4. The apparatus of claim 1, wherein, to perform the prediction procedure, the processor is configured to:
perform the prediction procedure to obtain a plurality of predicted reference signal measurements for the predicted downlink receive beam, wherein the predicted downlink receive beam corresponds to the predicted uplink transmit beam based at least in part on at least one predicted reference signal measurement of the plurality of predicted reference signal measurements satisfying a predicted reference signal measurement threshold.

5. The apparatus of claim 1, wherein, to perform the prediction procedure, the processor is configured to:
perform the prediction procedure to obtain a confidence metric associated with the one or more measurement predictions, wherein the predicted downlink receive beam corresponds to the predicted uplink transmit beam based at least in part on the confidence metric satisfying a confidence metric threshold.

6. The apparatus of claim 5, wherein the confidence metric is associated with a standard deviation of a mean for the one or more measurement predictions.

7. The apparatus of claim 1, wherein, to perform the prediction procedure, the processor is configured to:
perform the prediction procedure to obtain the one or more measurement predictions associated with a radio frequency spectrum band, wherein the threshold is associated with the radio frequency spectrum band.

8. The apparatus of claim 1, wherein, to perform the prediction procedure, the processor is configured to:
perform the prediction procedure to obtain the one or more measurement predictions associated with a beam direction from the network entity, wherein the threshold is associated with the beam direction from the network entity.

9. The apparatus of claim 1, wherein, to perform the prediction procedure, the processor is configured to:
perform the prediction procedure to obtain a predicted measurement for a spatial resource associated with the predicted downlink transmit beam and the predicted downlink receive beam, wherein the predicted downlink receive beam corresponds to the predicted uplink transmit beam based at least in part on the predicted measurement for the spatial resource satisfying the threshold.

10. The apparatus of claim 9, wherein the predicted measurement for the spatial resource is based at least in part on a mean of a plurality of predicted measurements for the spatial resource.

11. The apparatus of claim 9, wherein the spatial resource is a virtual resource of the network entity.

12. The apparatus of claim 9, wherein the spatial resource is associated with an angle of arrival at the network entity or an angle of departure from the network entity, or both.

13. The apparatus of claim 1, wherein, to perform the prediction procedure, the processor is configured to:
perform the prediction procedure to obtain a plurality of predicted measurements for a spatial resource associated with the predicted downlink transmit beam and the predicted downlink receive beam, wherein the predicted downlink receive beam corresponds to the predicted uplink transmit beam based at least in part on at least one predicted measurement for the spatial resource of the plurality of predicted measurements for the spatial resource satisfying the threshold.

14. The apparatus of claim 1, wherein the processor is configured to:
receive control signaling indicating a plurality of virtual resources of the network entity, wherein at least the predicted downlink transmit beam is associated with a virtual resource of the plurality of virtual resources.

15. The apparatus of claim 14, wherein the control signaling identifies a beam shape or beam pointing direction associated with each virtual resource of the plurality of virtual resources.

16. The apparatus of claim 1, wherein, to measure the one or more signals, the processor is configured to:
measure a channel state information reference signal or a synchronization signal block, or both, wherein the one or more measurement predictions are associated with measuring the channel state information reference signal or measuring the synchronization signal block, or both.

17. The apparatus of claim 1, wherein, to transmit the control message, the processor is configured to:
transmit the control message indicating the capability of the UE to support the beam correspondence between the downlink receive beam and the uplink transmit beam using a channel state information reference signal or using a synchronization signal block, or both.

18. The apparatus of claim 1, wherein, to transmit the control message, the processor is configured to:
transmit the control message indicating the capability of the UE to support the beam correspondence between the downlink receive beam and the uplink transmit beam based at least in part on a virtual resource of the network entity, an angle of arrival, an angle of departure of the network entity, or any combination thereof.

19. An apparatus for wireless communications at a network entity, comprising:
a memory; and
a processor coupled to the memory and configured to:
receive a control message indicating a capability of a user equipment (UE) to support beam correspondence between a downlink receive beam and an uplink transmit beam using beam prediction; and
transmit one or more signals using one or more downlink transmit beams of the network entity based at least in part on the capability of the UE to support beam correspondence between the downlink receive beam and the uplink transmit beam using beam prediction.

20-21. (canceled)

22. A method for wireless communications at a user equipment (UE), comprising:
transmitting a control message indicating a capability of the UE to support beam correspondence between a downlink receive beam and an uplink transmit beam using beam prediction;
measuring one or more signals using one or more downlink receive beams of the UE; and
performing a prediction procedure for a predicted downlink receive beam of the UE and a predicted downlink transmit beam of a network entity, wherein the predicted downlink receive beam corresponds to a predicted uplink transmit beam based at least in part on one or more measurement predictions satisfying a threshold.

23-30. (canceled)
